(19) United States
(12) Patent Application Publication
(10) Pub. No.: US 2008/0159725 A1
(43) Pub. Date: Jul. 3, 2008

(54) DVD PLAYER AND DISPLAY CONTROL METHOD THEREFOR

(75) Inventors: Mieko Onodera, Tokyo (JP); Yuki Kaneko, Tokyo (JP); Yasufumi Tsumagari, Tokyo (JP); Shinichi Kikuchi, Tokyo (JP); Yoichiro Yamagata, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/961,865

(22) Filed: Dec. 20, 2007

(30) Foreign Application Priority Data
Dec. 27, 2006 (JP) 2006-352316

(51) Int. Cl. H04N 5/00

(52) U.S. Cl. 386/126; 386/E05.064

(57) ABSTRACT

A DVD player includes a DVD player body that outputs a first image to a main display device, and a remote controller having a sub-display device. Herein, the DVD player body includes image data conversion unit that reduces the data amount of the first image and that converts the reduced first image into a second image for the sub-display device. The remote controller causes the sub-display device to display the second image transmitted from the DVD player body.

### CROSS-REFERENCE TO RELATED APPLICATIONS

This application claims the benefit of priority of Japanese Patent Application No. 2006-352316, filed Dec. 27, 2006, the entire contents of which are incorporated herein by reference.

### BACKGROUND

1. Field

The present invention relates to a DVD player and a display control method therefor, and more specifically, to a DVD player equipped with a remote controller, and a display control method therefor.

2. Description of the Related Art

Today, DVDs (digital versatile disks) for recording content such as movies and games are in widespread use, and a viewing style using a DVD player and a display device such as a television has been popularized.

Also, at present, as high-density recording type DVDs, for example, HD DVD (high definition digital versatile disk) players capable of playing back HD DVDs have also started hitting the market. HD DVD players can play back content that is much more fine and versatile than conventional DVD players.

Typically, when the DVD player is operated, a display devise such as a television is caused to display icons for various menus or for operations, and a user operates a remote controller on hand while viewing these screen images for operations.

It is also possible to operate the DVD player while viewing a movie or the like. At this time, a screen image such as an icon or the like for operation is superimposed on images that are currently being viewed. In this case, some of the images that are currently being viewed are undesirably hided by the icon or the like for operation.

JP-A 2000-175145 discloses a technique wherein, in order to avoid such a situation, a display device is provided to a remote controller, to thereby cause the display device such as a remote controller to display the icon or the like for operation, instead of causing the display device such as a television to display it.

On the other hand, when attempting to perform control using the remote controller while viewing the display device such as a television (hereinafter, referred to as a “main display”) from a distant place, its screen images are sometimes difficult to view. In such a case, it will be convenient if the display device for the remote controller (hereinafter, referred to as a “sub-display”) can display screen images that are of substantially the same images as that of the display device such as a television. However, when communications between the DVD player and the remote controller are made by infrared or radio, limitation on transmission capacity is not negligible.

Also, in a menu screen or the like, which is operated by the user while the user is viewing the main display, display of the main display is sometimes difficult for the user to operate depending on the size of the monitor screen to output. The major reason for this is as follows. In the HD DVD, the range of resolutions of videos recorded has been enlarged as compared with the case of the conventional DVD. Furthermore, in recent years, kinds of display sizes of the monitor screen have been increased. As a result, variations in display circumstances (combination of the output resolutions of content images and the display sizes of monitor screens) that can be selected by the user have significantly increased. Therefore, some of content is displayed in a state in which it is difficult for the user to operate, depending on the display circumstance. For example, there occurs problematic instances such as a case in which buttons of the menu screen are displayed on a large monitor dispersedly over a wide range, to thereby make it difficult to grasp all buttons, and conversely, a case in which small buttons are displayed on a small monitor, to thereby make it difficult to distinguish the buttons from one another.

The technique disclosed by the JP-A 2000-175145 is a technique for causing the remote controller to display just only simple figures such as icons, and is of a type quite asynchronous with content of a DVD under playback. In this sense, if a display in synchronization with screen images of the display device such as a television, that is, a display having substantially the same content as that of playback of the DVD player is displayed by a remote controller on hand, it is expected that operability is significantly enhanced. Moreover, if it is possible to cause the remote controller to display image information, combining it with a touch panel or the like allows the achievement of high operability of directly touching the screen of the remote controller to perform operation.

### SUMMARY OF THE INVENTION

Accordingly, it is an object of the present invention to provide a DVD player capable of causing a remote controller to display played-back images or high-visibility images for operation, and a display control method for the same.

To solve the above-described problems, the DVD player according to an aspect of the present invention includes a DVD player body that outputs a first image to a main display device; and a remote controller having a sub-display device. Herein, the DVD player body comprises image data conversion unit that reduces the data amount of the first image and that converts the reduced first image into a second image for the sub-display device. The remote controller causes the sub-display device to display the second image transmitted from the DVD player body.

To solve the above-described problems, a display control method for a DVD player according to another aspect of the present invention, the DVD player comprising a DVD player body that outputs a first image to a main display device, and a remote controller having a sub-display device includes the steps of: (a) reducing the data amount of the first image and converting the reduced first image into a second image for the sub-display device, and transmitting the second image from the DVD player to the remote controller; and (b) displaying the transmitted second image on the sub-display device.

According to the DVD player and the display control method therefor, it is possible to cause the remote controller to display played-back images or high-visibility images for operation.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a representation showing a usage example of a DVD player according to an embodiment of the present invention;

FIGS. 2A to 2D are representations of various mounting example of an embodiment of a remote controller;

FIG. 3 is a configuration example of a DVD player according to a first embodiment of the present invention;

FIG. 4 is a first representation of a display concept of advanced content for a main display device;

FIG. 5 is a second representation of a display concept of advanced content for the main display device;

FIG. 6 is a first representation of a display concept of standard content for the main display device;

FIG. 7 is a second representation of a display concept of standard content for the main display device;

FIG. 8 is a representation of a display concept of a sub-display device according to the first embodiment of the present invention;

FIG. 9 is a configuration example of a DVD player according to a second embodiment of the present invention;

FIG. 10 is a first representation of a display concept of advanced content in a sub-display device according to the second embodiment;

FIG. 11 is a second representation of a display concept of advanced content in a sub-display device according to the second embodiment;

FIG. 12 is a third representation of a display concept of advanced content in the sub-display device according to the second embodiment;

FIG. 13 is a fourth representation of a display concept of advanced content in the sub-display device according to the second embodiment;

FIG. 14 is a first representation of a display concept of standard content in the sub-display device according to the second embodiment;

FIG. 15 is a second representation of a display concept of standard content in the sub-display device according to the second embodiment;

FIG. 16 is a representation of a display concept of standard content in the sub-display device according to the first embodiment;

FIG. 17 is a representation of a display concept of advanced content in a sub-display device according to a third embodiment of the present invention;

FIG. 18 is a representation of a display concept of standard content in the sub-display device according to the third embodiment;

FIG. 19 is a block diagram of a DVD player according to the third embodiment;

FIG. 20 is an example of flowchart of display processing of images for the sub-display device;

FIG. 21 is a representation of a first display example in the sub-display device;

FIG. 22 is a representation of a second display example in the sub-display device;

FIG. 23 is a representation of a third display example in the sub-display device;

FIG. 24 is a representation of a fourth display example in the sub-display device;

FIG. 25 is a representation of a fifth display example in the sub-display device; and

FIG. 26 is a representation of a sixth display example in the sub-display device.

### DETAILED DESCRIPTION

Hereinafter, the DVD player and the display control method therefor according to embodiments of the present invention will be described with reference to the appended drawings.

### (1) First Embodiment

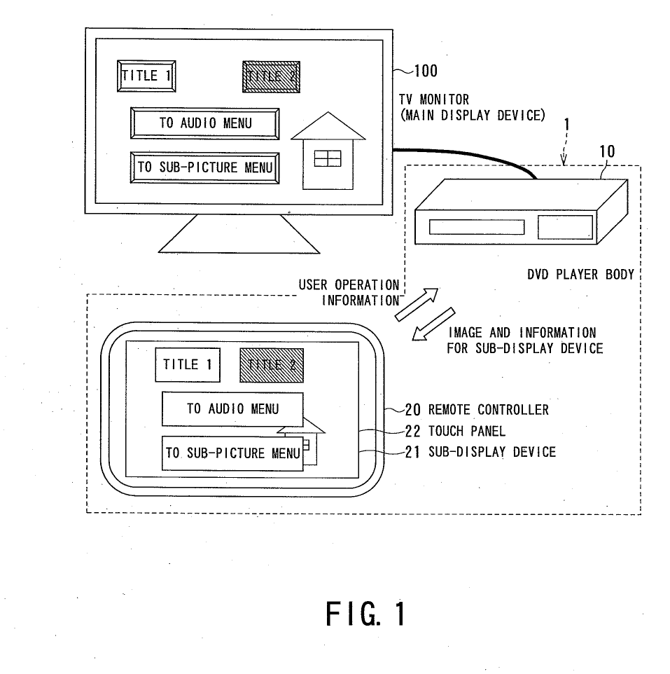

FIG. 1 is a representation showing a concept of usage of a DVD player 1 according to an embodiment of the present invention. The DVD player 1 includes a DVD player body 10 and a remote controller 20. The DVD player body 10 plays back image content or the like, e.g., recorded on an optical disk such as HD DVD. The DVD player body 10 outputs an image (first image) and/or sound to a TV monitor 100 equipped with a main display provided outside the DVD player 1.

On the other hand, the remote controller 20 is a portable device including a user-operated device 22 constituted, e.g., by a touch panel, and a sub-display device 21. The remote controller 20 operates the DVD player body 10 using the user-operated device 22, and displays an image (second image) for a sub-display device, generated by the DVD player body 10 on the sub-display device 21. The method for communications between the DVD player body 10 and the remote controller 20 is not particularly limited; for example, communications therebetween is performed by radio.

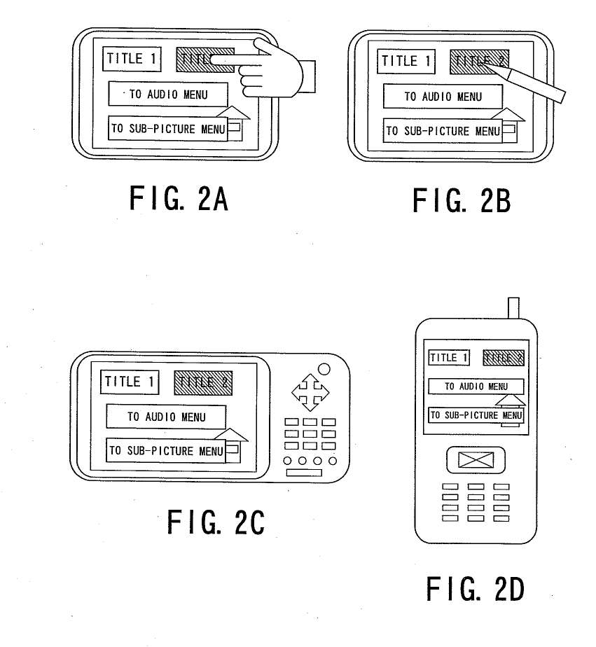

FIGS. 2A to 2D are representations showing various embodiments of the remote controller 20. The remote controller 20 shown in FIG. 2A is configured to have a touch panel operable by a finger, as the user-operated device 22, the touch panel being provided on the sub-display device 21. The remote controller 20 shown in FIG. 2B is configured to have a pen-type touch panel. The remote controller 20 shown in FIG. 2C is configured so that the user-operated device 22 for operating various buttons is provided adjacently to the sub-display device 21. The remote controller 20 shown in FIG. 2D is configured so as to be shared with a mobile phone.

In descriptions hereinafter, the DVD player body 10 that treats images for HD DVD is taken as an example of the DVD player body 10, but targets of the DVD player body 10 are not limited to images for HD DVD. The DVD player body 10 can be applied to images for Blue Ray disks or conventional images for DVD.

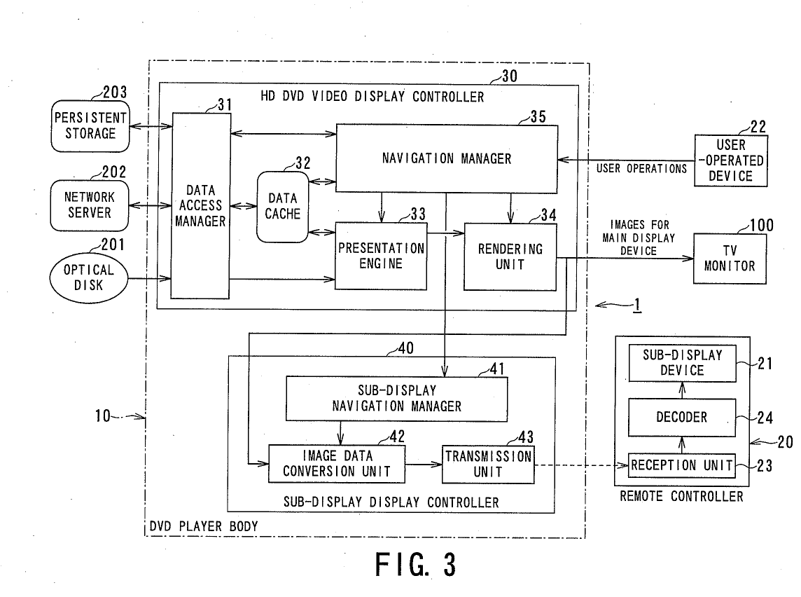

FIG. 3 is a configuration example of a DVD player 1 according to this first embodiment. The DVD player 1 includes the DVD player body 10 and the remote controller 20. The DVD player body 10 includes an HD DVD video display controller 30 that performs display control with respect to an image (first image) outputted to a TV monitor (main display device) 100, and a sub-display display controller 40 that performs display control with respect to an image (second image) outputted to the sub-display device 21 in the remote controller 20.

First, the outline of the configuration and operations of the HD DVD video display controller 30 will be described.

Image sources to be inputted into the HD DVD video display controller 30 include an optical disk 201 such as the HD DVD, a network server 202, and a persistent storage 203.

Also, information in response of an operation of a user is inputted from the user-operated device 22 in the remote controller 20.

The HD DVD video display controller 30 includes, as its internal construction, a data access manager 31, a data cache 32, a presentation engine 33, a rendering unit 34, and a navigation manager 35.

The data access manager 31 performs access control with respect to the optical disk 201, the network server 202, and the persistent storage 203. The data cache 32 is a portion for temporally storing image data under playback.

Upon receipt of operation information from the user-operated device 22, the navigation manager 35 performs overall control regarding the playback of images such as the selection of a kind of images to be played-back, or the setting of a playback start position.

The presentation engine 33 chiefly performs a function of separating packages of images or sounds from the inputted data and decoding each of the separated packages into image data or sound data. As described later, the rendering unit 34 performs superimposition of a plurality of kinds of images to thereby combine these images into one screen image.

The HD DVD video display controller 30 processes content of two systems: video content referred to as “advanced content”, having high-resolution and multifunction; and a video content referred to as “standard content”, having a resolution and functions that are substantially on the same order as those of the conventional DVD.

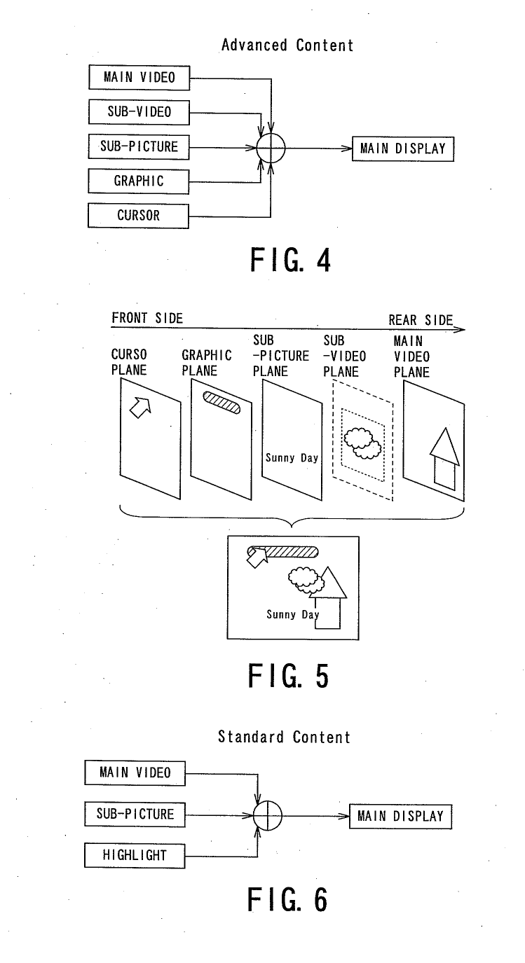

FIG. 4 and FIG. 5 are representations each exemplifying the outline of image superimposition of the advanced content. The advanced content include five kinds of images referred to as “main video”, “sub-video”, “sub-picture”, “graphic”, and “cursor”. Planes (screen images) of these images are superimposed on one another and combined into one plane by the rendering unit 34. The main video corresponds to a main image, the sub-video corresponds to a subsidiary image, and the sub-picture corresponds to a caption or the like. The graphic corresponds to a graphic image of selection buttons or the like used in the menu screen or the like, and the cursor corresponds to a cursor mark image moving under a user operation.

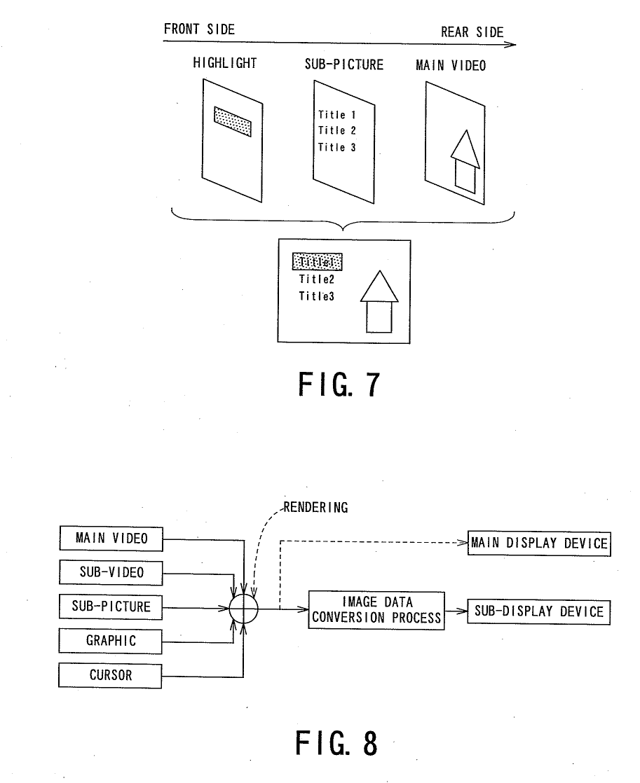

FIG. 6 and FIG. 7 are representations each exemplifying the outline of image superimposition of the standard content. The standard content include three kinds of images referred to as “main video”, “sub-picture”, and “highlight”. Planes (screen images) of these images are superimposed by the rendering unit 34 and combined into one plane, as in the case of the advanced content. In the standard content, the main video corresponds to a main image, and the sub-picture is used for a caption as well as letters for the menu and images for button figures. The highlight corresponds to an image for highlighting by superimposing it on the letters for the menu and the button figures.

In this manner, the rendering unit 34 in the HD DVD video display controller 30 superimposes the five kinds of images on one another in the advanced content, and superimposes the three kinds of images in the standard content, to thereby output them to the main display device in the TV monitor 100 on the outside.

On the other hand, the sub-display display controller 40 (refer to FIG. 3) generates an image that it causes the sub-display device in the remote controller 20 to display.

The sub-display display controller 40 includes a sub-display navigation manager 41, an image data conversion unit 42, and a transmission unit 43. The sub-display navigation manager 41 performs navigation for image playback under the control of the navigation manager 35 in the HD DVD video display controller 30, and also exerts general control over the sub-display display controller 40.

With respect to a high-density image combined by the rendering unit 34 in the HD DVD video display controller 30, the image data conversion unit 42 performs image data conversion process for reducing data amount and converting the image into easy-viewable image, as shown as “IMAGE DATA CONVERSION PROCESS” in FIG. 8. This is because there is a restriction on the capacity of communications between the DVD player body 10 and the remote controller 20.

As data conversion processes, for example, the following processes are performed.

The first is a process for reducing the resolution of an image. Image sources to be inputted from the optical disk 201, the network server 202, the persistent storage 203 and the like include resolution information or size information on display region, as attribute information on the main video or sub-video. In the process for resolution reduction, the data size is reduced by thinning pixels at a specified rate, or averaging pixels, based on the above-described resolution information or size information on a display region.

The second is a process for reducing the frequency of an image. The reduction in data size is performed by reducing the frame rate of the image and thinning the image in the direction of time, to thereby to reduce the frequency of the image. The above-described attribute information includes a portion describing a corresponding TV system (60 Hz/50 Hz), besides resolution and so on. From the above-described portion and the information on the resolution, the frame rate of image can be recognized. Based on this information on the frame rate, the frame rate is decreased to thereby reduce the data amount.

The third is a process for reducing the color gradation of an image. That is, this is a process for reducing display color gradation of the image, or making color image into monochrome image. Thereby, the data amount to be transferred to the remote controller 20 is reduced.

The fourth is a process for selecting a specified picture. The sub-display device 21 does not display all video picture, but selects a specified picture and outputs it, whereby the picture is thinned in the direction of time to reduce the data amount. The specified picture refers to, for example, the first one frame image of a package (unit of divided image).

The fifth is a process for extracting the outline of an image. The outline of an image is extracted by an image process, and the image is converted into an image having outline alone, thereby reducing the data amount.

The image data conversion unit 42 reduces the data amount by combining the above-described processes as appropriate, and an image for the main display device 100 (first image) is converted into an image for the sub-display device 21 (second image). The converted image for the sub-display device 21 is transmitted to the remote controller 20 via the transmission unit 43.

The remote controller 20 receives this image in a reception unit 23, and after having decoded the images by a decoder 24, the remote controller 20 displays it on the sub-display device 21.

### (2) Second Embodiment

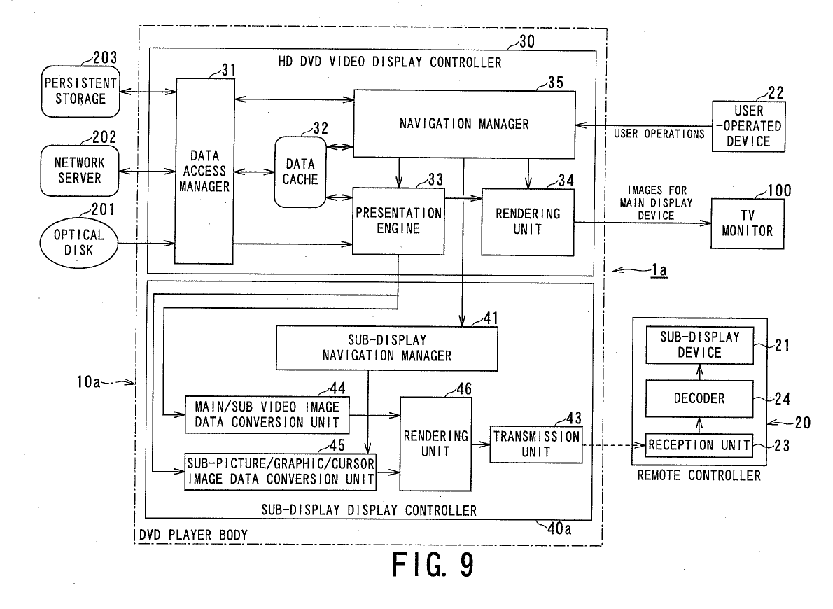

FIG. 9 is a configuration example of a DVD player 1 according to a second embodiment of the present invention. This embodiment is different from the first embodiment (FIG. 3) in the configuration of the sub-display display controller 40.

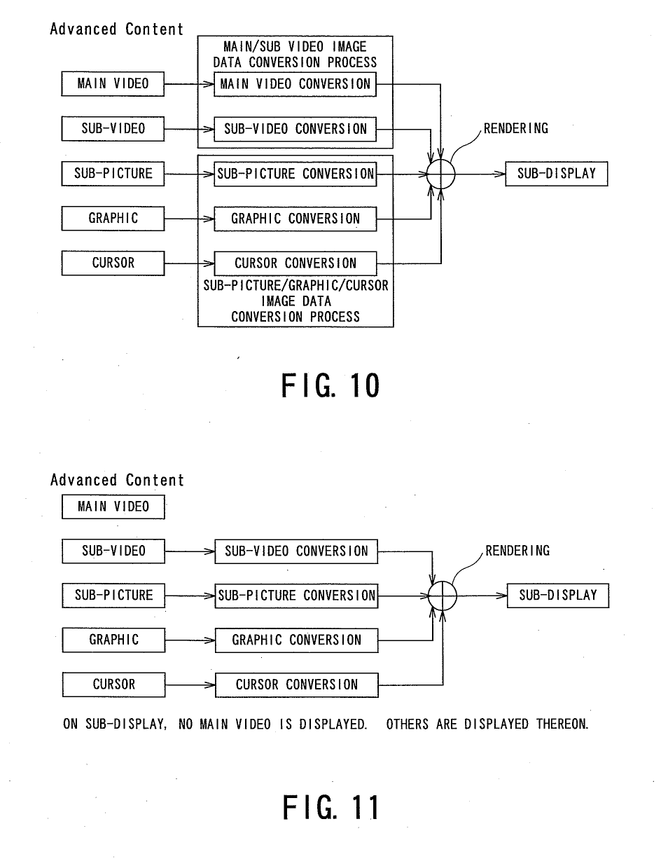

In the first embodiment, the sub-display display controller 40 is configured to perform image data conversion with respect to the image that has already been combined in the rendering unit 34 of the HD DVD video display controller 30. In contrast, the sub-display display controller 40a according to the second embodiment is configured to input images before combination from the HD DVD video display controller 30, and perform image data conversion for each kind of images such as main videos or sub-videos, as shown in FIG. 10, to thereby superimpose the converted images in the rendering unit 46 on each other and combine them.

Main video and sub-video, which are each mainly a moving image, differ from the sub-picture, graphic, and cursor, which are each a mainly still image, in the way of data amount reduction process. Therefore, in this embodiment, the ways of data amount reduction process are classified into two. That is, the above-described former group and latter group, respectively, are configured to be subjected to data reduction process in a main/sub video image data conversion unit 44, and a sub-picture/graphic/cursor image data conversion unit 45.

Because an icon for operation is often constituted by the sub-picture/graphic, it can be increased in the visibility by converting it separately from the main/sub-video image.

In the sub-picture/graphic/cursor image data conversion unit 45, besides the above-described data amount reduction processes, the following processes are performed.

The first is a process for simplifying an image. In this process, the outline of sub-picture/graphic/cursor image, or the size or shape of the object itself is recognized, and the image is converted into a simplified image, leading to a reduction in the data amount.

The second is a process for converting the size of an image. Out of the sub-picture/graphic/cursor images, images to be enhanced are converted into larger ones, and images not to be enhanced are converted into smaller ones. This process allows the enhancement of visibility of these images displayed on the sub-display device 21, e.g., the menu image.

The third is a process for position change. By displacing the display position of each image of sub-picture/graphic/cursor to an appropriated position, the visibility in the sub-display device 21 can be more increased.

The sub-display navigation manager 41 according to this embodiment is provided with a function of selecting kinds of images to be combined (a function as an image selection unit). By virtue of this function, the sub-display navigation manager 41 performs data reduction process with respect to only the images of the selected kinds, and thereupon, it superimposes these images on each other in the rendering unit 46 to combine them.

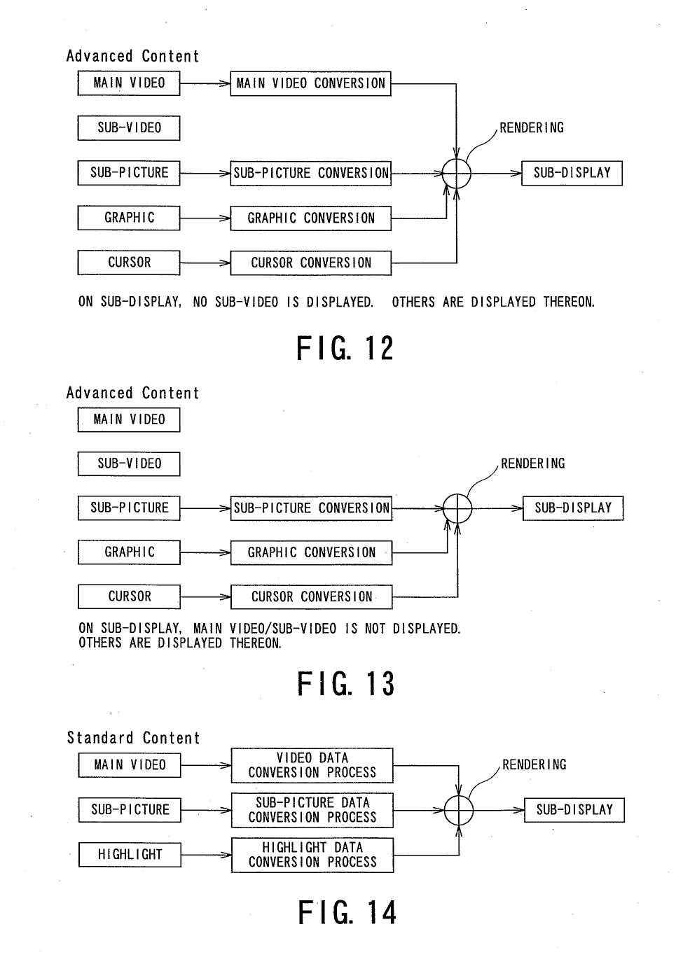

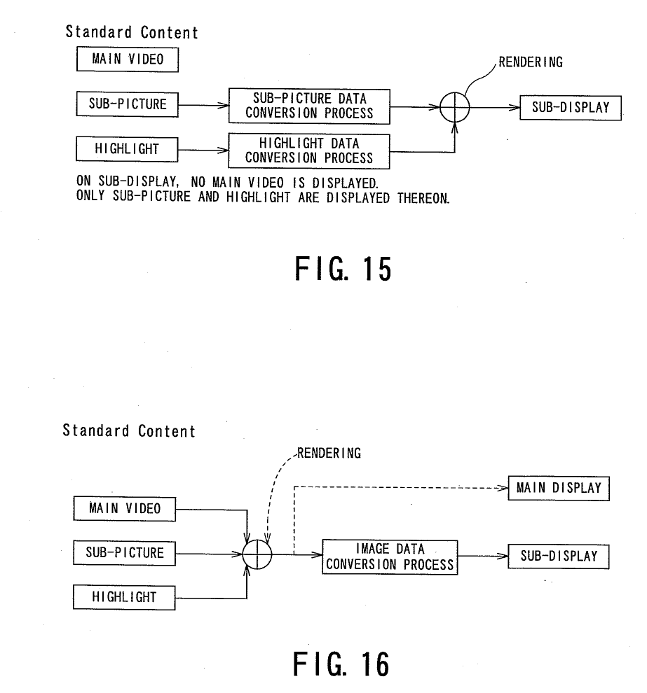

FIGS. 11 to 13 are representations each showing an example in which the above-described selection and conversion processes are performed with respect to the five kinds of images in the case of the advanced content. On the other hand, FIGS. 14 and 15 are representations each showing an example in which the above-described selection and conversion processes are performed with respect to the three kinds of images in the case of the standard content.

FIG. 16 shows a concept in the case where the standard content is displayed in the first embodiment. According to this concept, a rendering process is performed after a combination has been performed in the DVD player body 10.

### (3) Third Embodiment

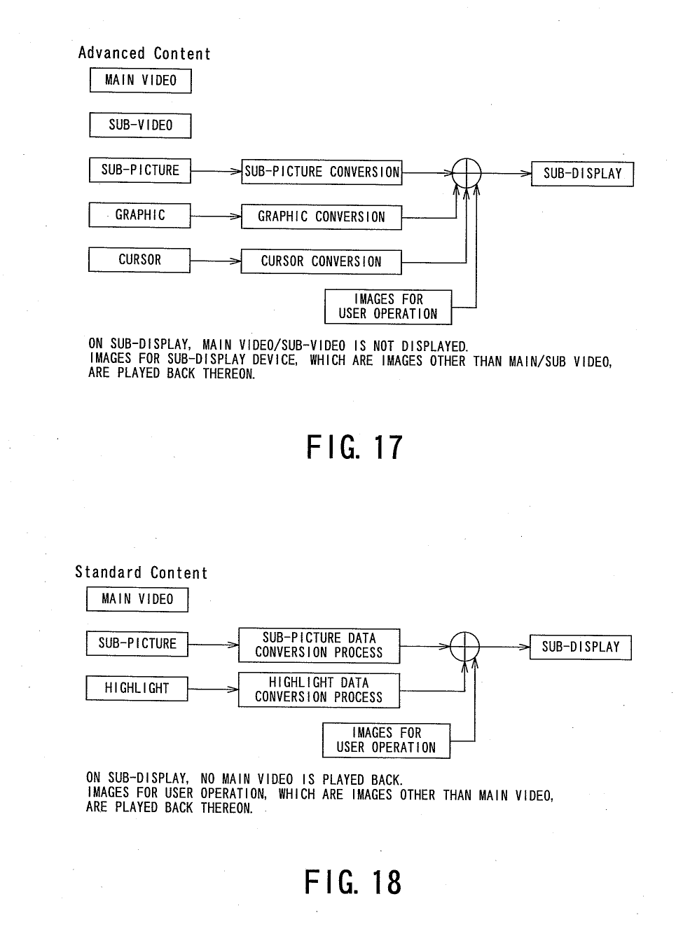

A DVD player 1b according to a third embodiment of the present invention is configured to cause the sub-display device 21 to display images other than displays of the main display device, in synchronization with the main display. Display concepts of this configuration are shown in FIGS. 17 and 18. Here, FIG. 17 is a display concept corresponding to the advanced content while FIG. 18 is a display concept corresponding to the standard content.

In the description hereinafter, while processes in the case of the advanced content are treated, the processes in the case of the standard content are substantially the same as the former.

The sub-display device 21 displays an image referred to as “image for user operation” (third image), exclusively used for user operation, by rendering (superimposing) it on the sub-picture/graphic/cursor images, instead of displaying a main video or a sub-video.

The image for user operation may be configured so that the user can freely set an image of a fixed pattern, or alternatively may be configured to be made an image preliminarily worked for the sub-display device 21 from a video output of content. Still alternatively, the image for user operation may be configured so that a content provider has provided the image for user operation in conformance with this content and that the user downloads in advance the image for user operation from a network. The image for user operation can be stored or generated in various formats such as an elementary stream format for video alone, and a program stream format.

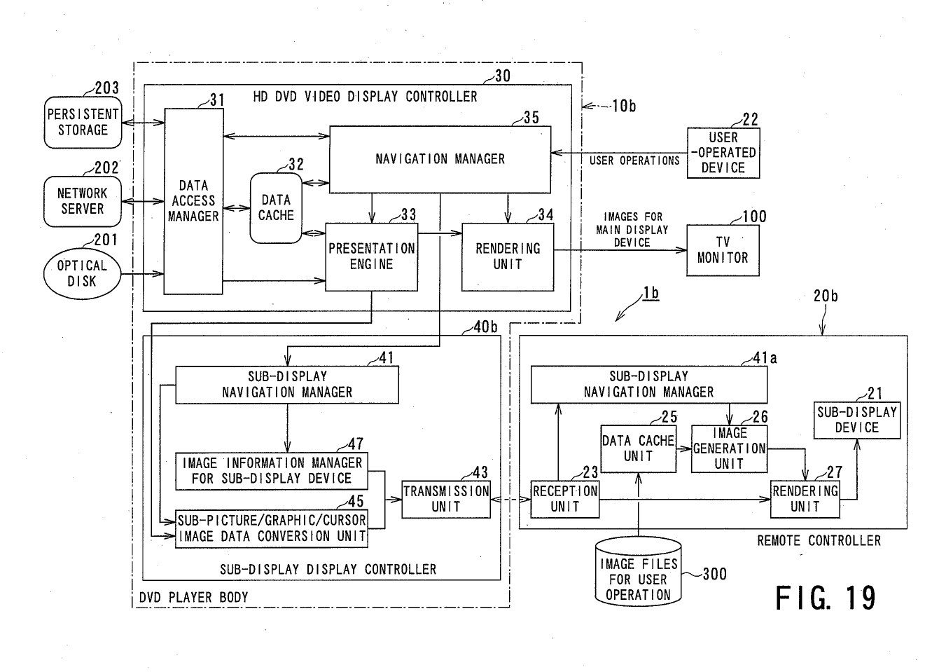

FIG. 19 is a configuration example of a DVD player 1b according to the third embodiment. A sub-display display controller 40b in the DVD player body 10b includes a sub-display navigation manager 41, a sub-picture/graphic/cursor image data conversion unit 45, an image information manager for the sub-display device 47, and a transmission unit 43.

A remote controller 20b according to the third embodiment includes a sub-display navigation manager 41a, a data cache unit 25, an image generation unit 26, and a rendering unit 27, in addition to the reception unit 23 and the sub-display device 21.

Into the remote controller 20b, image files for user operation 300 are also inputted from the outside.

In the third embodiment, by providing the remote controller 20b with the sub-display navigation manager 41a, the data cache unit 25, the image generation unit 26, and the rendering unit 27, even the remote controller 20b can input display-position/size/color information on images, or buttons for user operation in a way other than the way in which they are provided from image sources, that is, can input them from the outside in the form of image files for user operation, to thereby generate images. As a result, the amount of transfer data between the DVD player body 10a and the remote controller 20b can be reduced.

Input methods for the image files for user operation 300 are not particularly limited. The image files for user operation 300 may be inputted from a detachable recording medium such as a USB memory. Also, if the remote controller 20b has a communication function such as a mobile phone, the image files for user operation 300 may be inputted from a network server via the Internet.

How to take display synchronization with the main display device is to receive only the title of images under playback and time information from the sub-display navigation manager 41 provided in the sub-display display controller 40b (this function is implemented by the image information manager for the sub-display device 47), and then to play back an image stored in advance in the data cache unit 25 of the remote controller 20b, in keeping with the time information. Here, the title under playback and the time information can be obtained from attribute information on the images under playback.

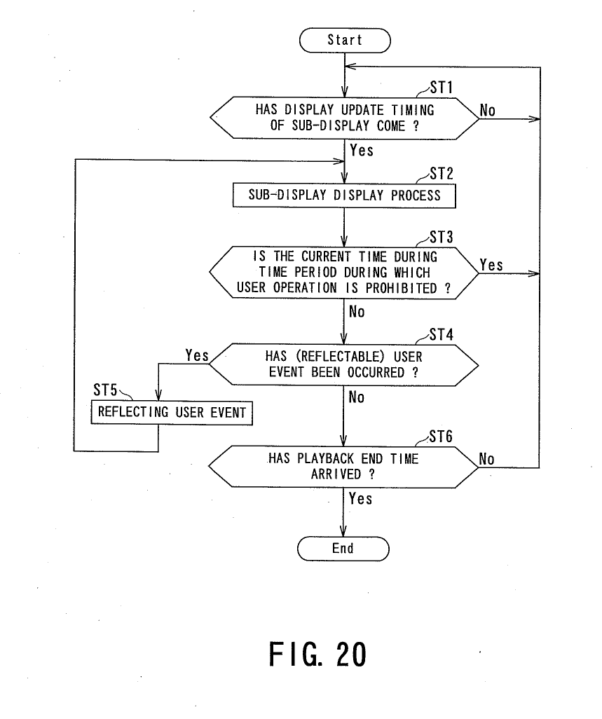

FIG. 20 is an example of flowchart of display processing of images for the sub-display device 21 under playback of content. First, it is determined whether display update timing of sub-display has come (step ST1). The display update timing of sub-display differs depending on the substance of an image data conversion process. For example, when the process for reducing the frequency of an image or the process for selecting a specified picture is not performed, the display update timing of sub-display is basically the same as the display timing with respect to the main display device. On the other hand, when the process for reducing the frequency of an image is performed, the display update timing of the sub-display becomes a timing corresponding to a frame rate after the image has been thinned. Also, when the process for selecting a specified picture is performed, a playback timing of the specified picture becomes the display update timing. Furthermore, when neither of the main video and the sub-video is displayed on the sub-display device 21 (second embodiment: FIGS. 13 and 15), a timing in which the sub-picture/graphic/cursor image has been changed from the previous frame image, may be taken as the display update timing. By these display update timings, sub-display processes are performed. If the display update timing has not yet come, it is necessary to stand by, with the current display unchanged, until the display update timing arrives (“No” determination in step ST1).

The sub-display process in step ST2 is a display process according to the above-described embodiment. While a sub-display display is performed, if the current time is not during the time period during which a user operation is prohibited, the user operation is in an acceptable state. This determination is performed in step ST3.

In the state in which the user operation has been accepted, if a user event such as operation of selecting/determining buttons occurs (“Yes” determination in step ST4), and user operation information is transmitted to the DVD player body 10, the user event is reflected (step ST5). The sub-display display process is again performed to update the sub-display display.

On the other hand, if the user event does not particularly occur (“No” determination in step ST4), and a playback end time arrives (“Yes” determination in step ST6), the sub-display display ends. These processes are repeated until the playback end time arrives. Here, the above-described determination whether the current time is during the time period during which a user operation is prohibited, is made based on the attribute information on an image.

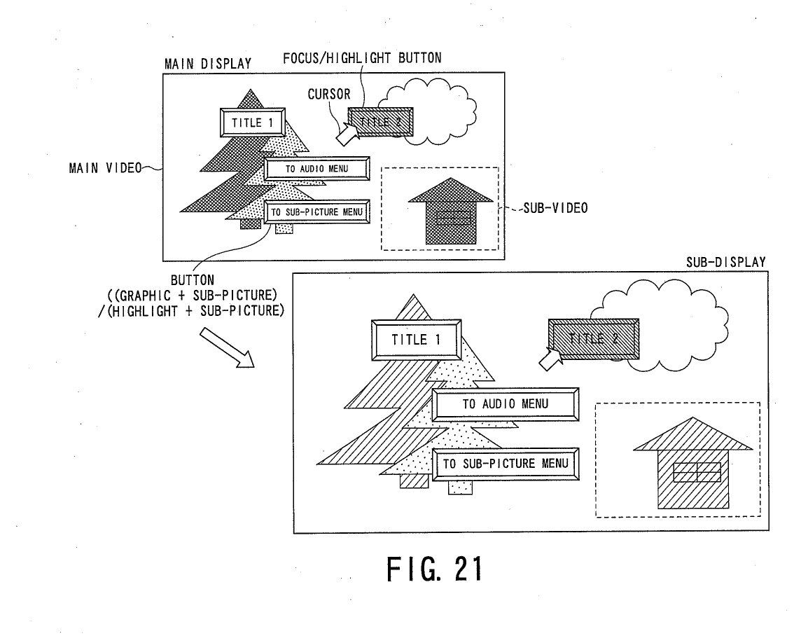

FIGS. 21 to 26 shows display examples of the sub-display device 21 in the above-described embodiments in comparison with displays of the main display device.

FIG. 21 shows a first display example. In the display of the main display device, a sub-video is displayed on a main video in the form of a picture-on-picture, and further, on those, a graphic (highlight, in the case of standard content) or buttons constituted by a sub-picture, and a cursor image indicating instruction pointer of the user are displayed.

In contrast, in the display of the sub-display device 21, the above-described image data conversion process is performed to reduce the resolution of an image and decrease the display color gradation.

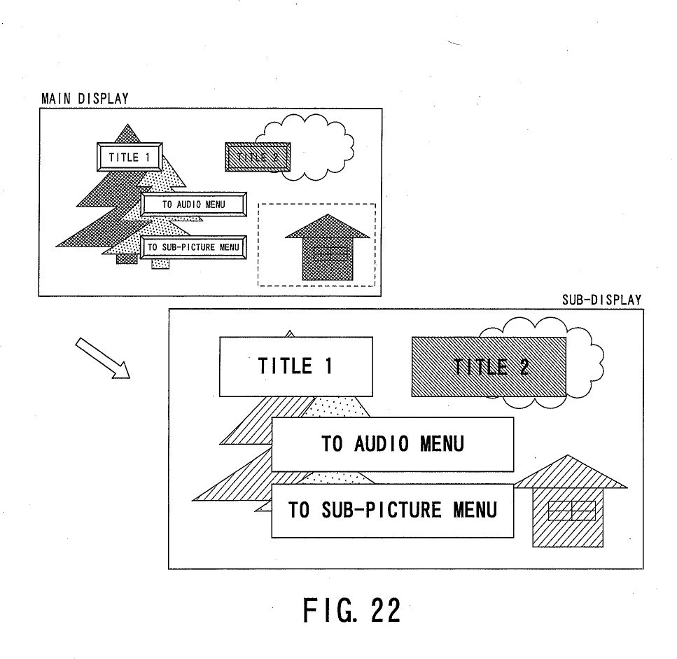

FIG. 22 shows a second display example. The data size of the main video and the sub-video are reduced by the image data conversion process as in the case of the first display example. Furthermore, regarding the graphic (or highlight) and the sub-picture, by performing the simplification of the image and changing the size, using the sub-picture/graphic/cursor image data conversion unit 45, button images are converted into easy-to-see and high-visibility images as well as the data size is reduced.

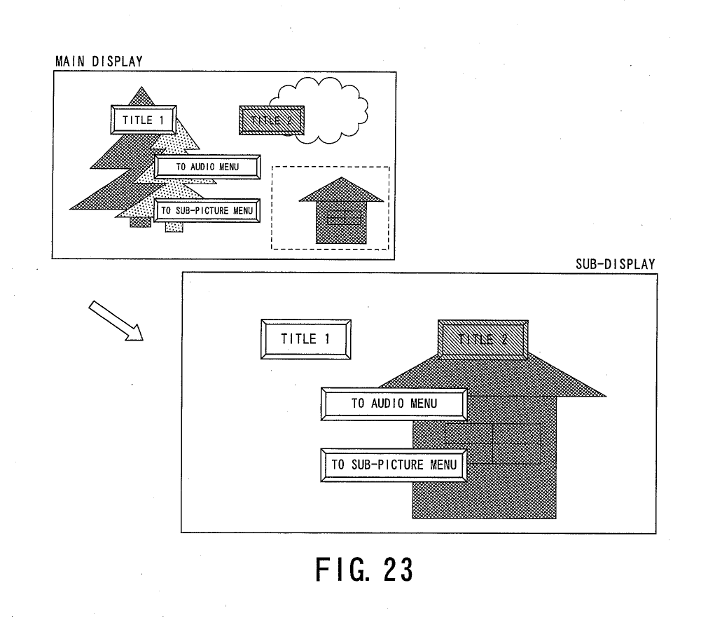

FIG. 23 shows a third display example. In this display example, the main video is not adapted to be displayed on the sub-display device 21, so that it is unnecessary to transfer information on the main video to the remote controller 20, which leads to a reduction in the transfer data size.

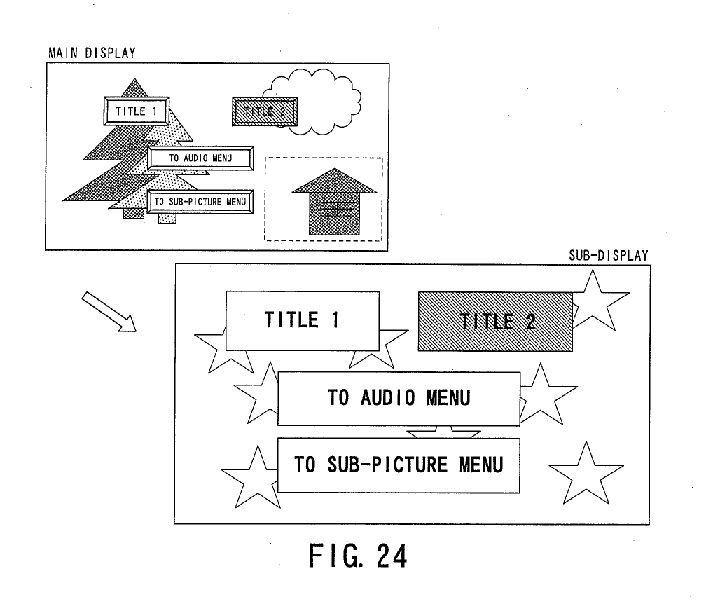

FIG. 24 shows a fourth display example. In this display example, an image for user operation, according to the user's preference and unrelated to the main video or the sub-video for the main display device, is inputted from the outside, and displayed in the back screen of the sub-display device 21. This is a display example of the DVD player 1b according to the third embodiment. As in the case of the second display example, operation button images that are converted into easy-to-see images and also reduced in the data size by performing the simplification of the image and the changing of the size, are superimposed on the back screen image.

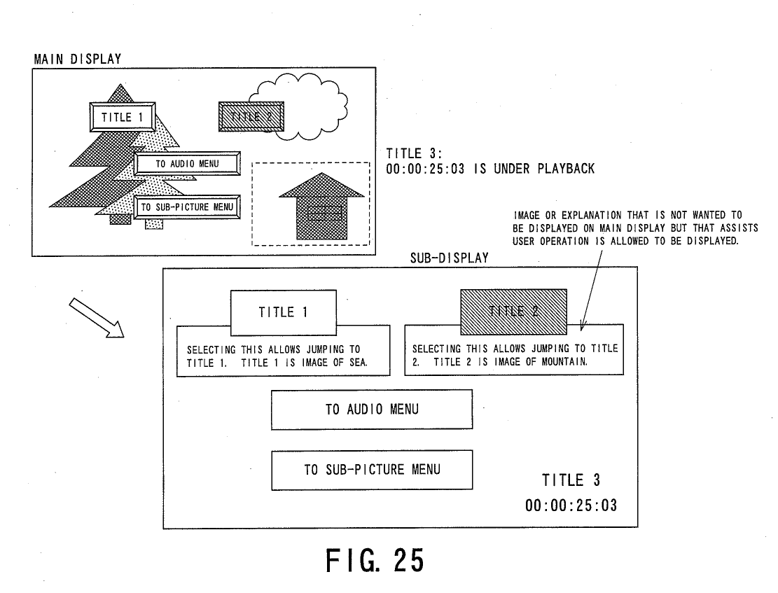

FIG. 25 shows a fifth display example. This is a display example corresponding to the configuration such that a content producer has provided images for user operation, in conformance with content to be played back, and the user downloads in advance from a network. This display example also corresponds to the third embodiment. In this case, based on playback time information transferred from the DVD player body 10b, a display can be performed in synchronization with that of the main display. For example, as shown at the bottom right corner of the fifth display example, the playback time of a title can also be displayed. Moreover, when there is information that the content producer does not want to display on the main display but that assists operation, this information is displayed in the vicinity of a title display as images for user operation, whereby the information that assists operation can be displayed on the sub-display device 21 without affecting displays of the main display device.

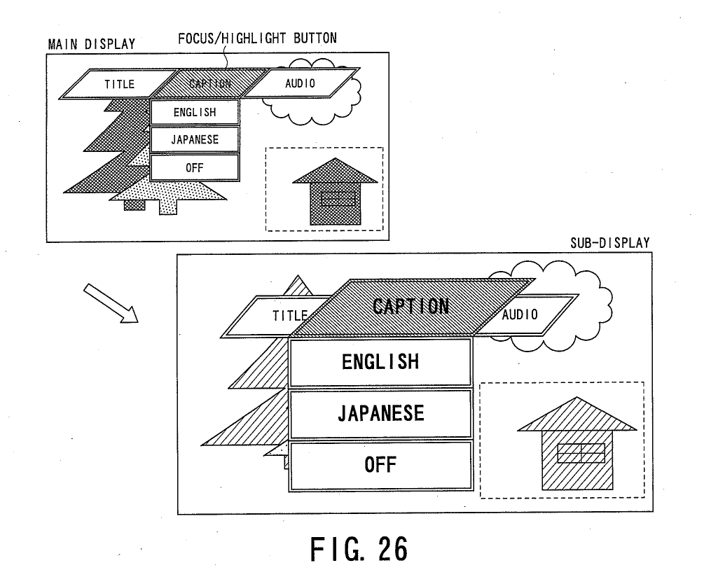

FIG. 26 shows a sixth display example. In this display example, buttons are detected that are being currently focused (highlighted), or, that are being selected by the user, and after having performed a conversion process such as an enlarged display so as to enhance the buttons, these buttons are displayed. This conversion process is performed by the sub-picture/graphic/cursor image data conversion unit 45 according to the second and third embodiments. Highlighting the buttons that are being selected brings about a sub-display display that is easy for the user to operate.

As described above, the DVD player and the display control method therefor according to the above-described embodiments, it is possible to cause the remote controller to display images or high-visibility images for operation.

The present invention is not limited to the above-described embodiments. In an implementation phase, the present invention can be embodied by modifying components without departing from the true spirit and the scope of the present invention. Also, by appropriately combining a plurality of components disclosed in the above-described embodiments, the invention including various embodiments can be constituted. For example, some components may be eliminated out of all components represented in the embodiments. Furthermore, components across different embodiments may be appropriately combined.

What is claimed is:

1. A DVD player comprising:
a DVD player body configured to output a first image to a main display device; and
a remote controller comprising a sub-display device,
wherein the DVD player body comprises an image data conversion unit configured to reduce the data amount of the first image to produce a reduced first image and to convert said reduced first image into a second image for the sub-display device, and
wherein the remote controller is configured to cause the sub-display device to display the second image.

2. The DVD player according to claim 1, wherein the DVD player body further comprises:
an image selection unit configured to select, from among a plurality of kinds of first images, a first image of a designated kind or a predetermined kind; and
a rendering unit configured to superimpose a plurality of second images on each other, said second images having been selected by the image selection unit and having been converted by the image data conversion unit.

3. The DVD player according to claim 1, wherein the image data conversion unit is configured to convert an image for user operation contained in the first image into an easily-viewable image.

4. The DVD player according to claim 1, wherein the remote controller further comprises:
an image generation unit configured to generate a third image based on an image file input from outside of the DVD player; and
a rendering unit configured to superimpose the second image transmitted from the DVD player body and the third image on each other to produce a superimposed image, the rendering unit further configured to cause the sub-display device to display the superimposed image.

5. The DVD player according to claim 1, wherein the first image is an image conforming to the HD DVD standards.

6. A display control method for a DVD player comprising a DVD player body configured to output a first image to a main display device, and a remote controller comprising a sub-display device, the method comprising:
reducing the data amount of the first image and converting the reduced first image into a second image for the sub-display device, and transmitting the second image from the DVD player body to the remote controller; and
displaying the transmitted second image on the sub-display device.

7. The display control method for a DVD player according to claim 6 further comprising: selecting the first image comprising selecting an image of a designated or predetermined kind from among a plurality of kinds of images;
superimposing a plurality of second images on each other to produce a superimposed image, said second images having been converted from the selected first image; and
transmitting the superimposed image to the remote controller.

8. The display control method for a DVD player according to claim 6, further comprising converting an image for user operation contained in the first image into an easily-viewable image.

9. The display control method for a DVD player according to claim 6, further comprising:
generating a third image based at least in part on an image file inputted from outside the DVD player; and
superimposing the second image and the third image on each other to produce a superimposed image, and causing the sub-display device to display the superimposed image.

10. The display control method for a DVD player according to claim 6, wherein the first image is an image conforming to the HD DVD standards.
